(19) United States
(12) Patent Application Publication
(10) Pub. No.: US 2021/0113941 A1
(43) Pub. Date: Apr. 22, 2021

(54) Filtration Device and Method

(71) Applicants: Howard Martin Britton, Upper Marlboro, MD (US); Timothy Wilder Rolf, Washington, DC, DC (US)

(72) Inventors: Howard Martin Britton, Upper Marlboro, MD (US); Timothy Wilder Rolf, Washington, DC, DC (US)

(21) Appl. No.: 16/657,011

(22) Filed: Oct. 18, 2019

(51) Int. Cl. B01D 21/26; C01G 49/06; B01D 43/00

(52) U.S. Cl. CPC B01D 21/26; C02F 2101/20; B01D 43/00; C01G 49/06

(57) ABSTRACT

Our method and system for fluid and gas filtering uses nano-porous iron oxide (NIO) particles, specifically Fe₂O₃ particles, of a specific and unique pore architecture and particle size that enables dual process filtration via concurrent adsorption (via particle exterior) and absorption (via nano-porous particle interior). This concurrent dual process filtration method is far more efficient and faster than any prior art for other flocculation or sorbent techniques that remove toxins from water, including dissolved toxins. NIO has specific utility in removing phosphates, toxic heavy metals, and when used in conjunction with UV light, water-soluble perfluorophosphonic and perfluorosulphonic acid compounds. NIO is projected to perform best as a water purification source point sorbent and finishing agent. The physical properties demonstrated by these nano-porous iron oxide particles of specific size and porosity can also be used in other fluid applications and gas purification applications.

### BACKGROUND OF THE INVENTION

“Flocculation, in the field of chemistry is a process in which colloids come out of suspension in the form of floc or flake, either spontaneously or due to the addition of a clarifying agent. The action differs from precipitation in that, prior to flocculation, colloids are merely suspended in a liquid and not actually dissolved in a solution. In the flocculated system, there is no formation of a cake, since all the flocs are in the suspension. Coagulation and flocculation are important processes in water treatment” (or other filtering of fluids) “with coagulation to destabilize particles through chemical reaction between coagulant and colloids, and flocculation to transport the destabilized particles that will cause collisions with floc” (Wikipedia.org: 2019-09).

The filtering for fluid, including liquid and gas, is extremely important for multiple reasons, including, e.g., for recycling, environmental cleaning, toxic removal, drinking water, allergy reduction, gathering precious material, filtering specific material, semiconductor processing and production, purification, medical reasons, medical supplies, laboratory work, experimental parameter control, and standardization. One aspect of filtering is removal of particles or substances from the fluid, such as from water or air.

In Adsorption, the process creates a film of the adsorbate on the surface of the adsorbent (e.g., see Wikipedia), e.g. sticking to the outside surface of filtration media. This process differs from Absorption, in which a fluid is dissolved by or permeates a liquid or solid, respectively, e.g., sticking in the porous internal surface inside filtration media that has a sponge-like architecture.

If one can use both mechanisms above concurrently, the result is more efficient, more complete, and faster. If a metal or oxide filtration media is nano-porous, it can internally absorb. If we increase the surface area of smaller particles (especially those with a chemical affinity for the pollutants targeted for remediation,) it increases remediation speed and capacity. So, when absorption+adsorption occur concurrently, all effects/benefits/advantages are enabled in our solution, as described below.

In our related patent application, previously, Ser. No. 14/102,420, titled Filtration Device and Method, now as U.S. Pat. No. 9,504,954, Rolf et al., previously issued in November 2016, we have discussed a sorbent air filtration device. All of the teaching in that application is incorporated herein by reference.

The focus of our 1st patent above was a filtration device, using a single+unique sorbent. The focus of our 2nd patent, here, is improved water remediation by:
eliminating filtration device &
using nano-porous iron oxide (NIO) as a dual remediation process clarifying agent and sorbent in flocculation applications.

There are many clarifying agents, including iron based salts and anhydrous compounds, but we are the first using Iron Oxide in the manner/system described below, with its many advantages over the prior art, as shown below.

For example, see the article by C. Caterina Borghi, Massimo Fabbri, Maurizio Fiorini, Maurizio Mancini, and Pier Luigi Ribani, titled Magnetic Removal Of Surfactants From Wastewater Using Micrometric Iron Oxide Powders, in Separation and Purification Technology, Volume 83, 15 Nov. 2011, Pages 180-188, in which magnetism is used to remove the impurities, with the abstract shown below:

The aim of Borghi (et al)'s paper “is the study of a sustainable process for the treatment of urban wastewater able to reduce surfactant concentrations close to the back-ground levels or, at least, lower than the values allowed by law for a reuse in agriculture. The considered process is based on the adsorption of surfactants (water diluted) on commercial iron oxide powders and their removal in a magnetic filtration system. The powders of hematite and magnetite used have a diameter of 0.5, 1 and 5 μm, respectively; they are non-toxic for humans and the environment and they have a relatively low cost. The removal of surfactants on a laboratory scale at concentrations in the wastewater range (0.2-4.2 mg/l) was studied applying the treatment on pure surfactants, mixtures of pure surfactants and detergents. With regard to the adsorption on magnetite, despite the large quantity of powder required (17-51 g/l), the tests led to positive results for cationic surfactants (up to 90% of removal) and relatively good for the anionic (up to 20%) and non-ionic ones (up to 40%). Adsorption on hematite has shown encouraging results with regard to all surfactants (from 50% to higher than 90% of removal) with a much lower amount of powder required (1-17 g/l). In all cases the adsorption took 10 min and the magnetic separation of the iron oxides was fully achieved after 10 min of filtration.”

Thus, Borghi (et al)'s method is different from our method, as iron oxide is non-magnetic, so we do not use the magnetic means for the filtering process. Therefore, our method is different from the prior art, as shown below.

Other flocculation chemicals used in industry are different from ours, i.e., using Fe₂O₃. Thus, our method is different from the prior art, as shown below.

### SUMMARY OF THE INVENTION

In one embodiment, we describe a method and system that uses iron oxide for cleaning or clearing the fluid, e.g., water. For example, we are using Fe₂O₃, e.g., nano-porous, which has greater surface area and hence is more absorbent.

In Appendix 1, we have shown the details of experiments on our material as to what it can do, with the specific properties/performances. The lab report is done by PTL/Particle Technology Labs (Downers Grove, Ill.), for Engineered Data LLC, to get the key parameters and advantages, over the prior art/others in the industry. For example, on page 2 of the report of Appendix 1, we have “BET Specific Surface Area”, as one parameter, which is the surface area calculated on the BET model, normalized by the sample mass. For example, on page 3, we have: BET surface area as: about 246 m²/g.

In general, for a given mass/amount of an object, the higher the surface area, or the higher total or effective cross section, the higher the chance to capture the impurities/particles, or more capture rate of impurities, or more efficiency or faster capture, or better filtering or cleaning, or more compact or smaller footprint, or more desirable system for filtering/material, or cleaner fluid at the end.

For example, for other methods, for the same unit, for comparison, we have 40-60 range (m/g), which is about 4-6 times lower value than ours, i.e., 4-6 times lower/worse than our performance. So, ours is much better/more superior than that of prior art/others in industry, by a factor of at least 4×.

### BRIEF DESCRIPTION OF THE DRAWINGS

FIG. 1 is for one embodiment, as an example, for the apparatus.

### DETAILED DESCRIPTION OF THE PREFERRED EMBODIMENTS

In one embodiment of the invention, we have a better material/system for cleaning/filtering the fluid/water, to get the particles/materials out of the fluid. In water filtration, larger particles are generally easier+cheaper to remediate than smaller particles. Hence dissolved toxins are the hardest+costliest to remediate. Our invention remediates dissolved toxins in large quantities at fast speeds.

Appendix 1 describes/explains the following: Fe₂O₃ on page 1, in-situ vacuum degassing conditions on page 1, absorbate gas on page 1, total volume (cm3/g) on page 1, pore size range (nm) on page 1, total area (m2/g) (which is a very important parameter (the higher, the better for us)) on page 1, pore volume on page 1, and pore area on page 1.

Appendix 1 describes/explains the following, for our embodiments/systems/methods:
Interpreting our micro-mesopore analysis by gas physisorption (static volumetric method) on page 2;
BET specific surface area on page 2;
Adsorption/desorption cumulative volume of pores on page 2;
Adsorption/desorption average pore diameter on page 2;
Total volume in pores on page 2;
Total area in pores on page 2;
Cumulative surface area vs. pore width on page 2;
d A/d (log (W)), surface area vs. pore width on page 2, which is the derivative of A with respect to the log of W;
Cumulative pore volume vs. pore width on page 2;
Pore size log goodness of fit & pore size goodness of fit, on page 2;
Surface area & pore volume & pore size, on page 3;
Isotherm tabular report for relative/absolute pressure, quantity adsorbed, elapsed time, and saturation pressure, on page 4;
Isotherm tabular report for relative/absolute pressure, quantity adsorbed, elapsed time, and saturation pressure, on pages 5-6;
Isotherm linear plot on page 7;
Isotherm Log plot on page 8, with relative pressure on x-axis as Log scale;
BET report with surface area & molecular cross sectional area, on page 9;
Surface area plot on page 10;
Sample density on page 10;
Adsorption pore distribution report on page 11;
Pore diameter range in nm, average diameter, incremental pore volume, cumulative pore volume, incremental pore area, and cumulative pore area, on page 12;
Adsorption cumulative pore volume curve on page 13;
Adsorption cumulative pore area curve on page 14;
Adsorption—derivative of A with respect to (Log) D−pore area curve on page 15;
Desorption pore distribution, with correction, including table for pore diameter range, average diameter in nm, incremental pore volume, cumulative pore volume in cm3/g, incremental pore area in m2/g, cumulative pore area in m2/g, on pages 16-17;
Desorption cumulative pore volume curve on page 18;
Desorption cumulative pore area curve on page 19;
Desorption—differential of A w.r.t. log(D)−pore area curve, on page 20;
Pore table, for pore width, pore volume, pore area, both cumulative and incremental, on pages 21-24;
Porosity distribution, on page 25;
Isotherm table on pages 25-30, including relative pressure, quantity adsorbed, both experimental & fitted, and residual, both relative & absolute values;
Cumulative surface area vs pore width curve, on page 31;
Differential of A w.r.t. Log of W−surface area vs pore width curve, on page 32;
Cumulative pore volume vs pore width curve, on page 33;
Goodness of fit, with standard deviation, on pages 34-35.

Therefore, in Appendix 1, we have proven our superiority/advantages with respect to the current technology/techniques, e.g., in terms of effective concurrent internal+external surface area, being large, to capture more impurities, for a given volume or weight/mass. Nano porous iron oxide is non-stoichiometric and exhibits superior atom economy over existing filtrates used in water treatment.

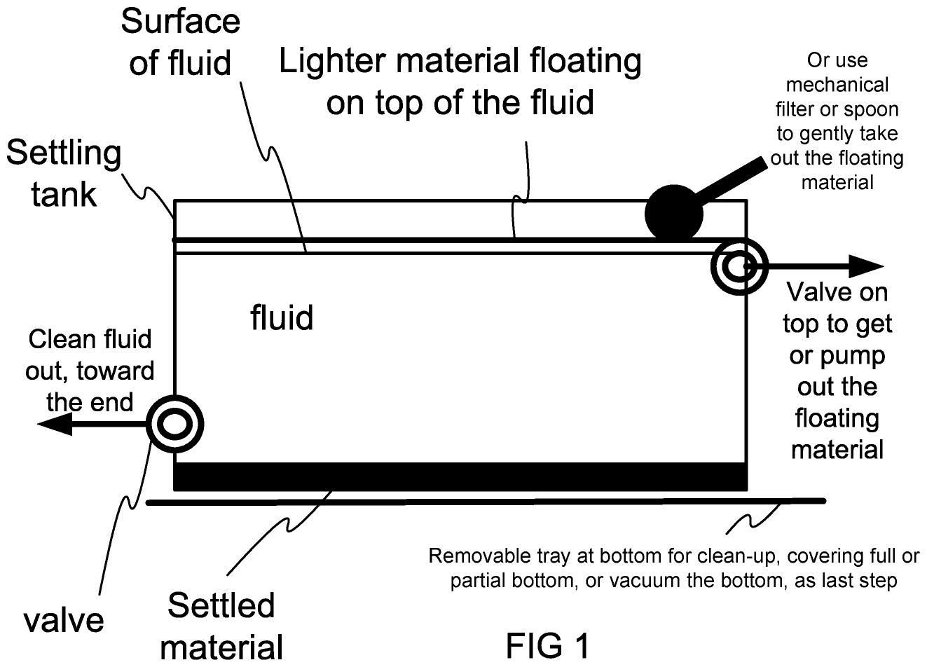

FIG. 1 is for one embodiment, as an example, for the apparatus.

Now, let's consider the following situation, which we have:
Approximately 90 percent of all pores are micro-pores (less than 2 nm size, as smallest ones), which have about 50 percent of all total areas;
Approximately 10 percent of total number as meso-pores, as bigger pores, of 2-50 nm size, which have about 50 percent of all total surface areas, for capturing particles/impurities.

High surface area materials are traditionally associate with nano-powders. Nano-powders are not suited for water filtration, because once they are introduced into water being treated for pollution, they are logistically impossible to completely remove, inevitably dissolving back into polluted water, leaving polluted water in a worse condition than it previously was. Our nano porous iron oxide particles are approximately 1000× larger than nano-powders, and can be removed from water being treated for pollution either via gravity settling or membrane separation processes.

In general, desorption occurs when adsorbed and absorbed materials gradually leach back into the fluid/water again. This desorption process slowly begins after approximately 2 hours detention time, leading to 100% desorption in as little as 24 hours.

In one example, we have a container with about 10 ml of water containing phosphate, mixed with nano porous iron oxide in a tank, for gravity settling, where the top water is wired off, and particles at the bottom stays there, i.e., filtered out, without any agitation, leaving the bottom material to be taken out later, as filtered material.

In one example, we have nano-porous iron oxide, or NIO, as our material.

One difference with prior art is that their particles are in the diameter range of 0.5, or 1, to 5 microns, whereas ours is between 2.5 to 90 microns. So, ours are much larger in average, and in the range, with much larger upper end/sizes.

The toxin concentrations that they are claiming removing, e.g., for Borghi et al., mentioned above, are from 0.2 to 4.2 mg/L. The toxin concentrations our NIO/technology removes are over 6 times greater than that of Borghi's method (up to 27.5 mg/L), and this could be even higher (as the max concentration level our Refractometer could measure is just 30 mg/L). So, ours is much more efficient in removing the toxins.

Their powder dosage quantities are “large” (Range of 17-51 g/L). NIO dosage is 6 g/L (for ours). So, dramatically less NIO is required to achieve superior remediation performance.

Our NIO is nano-porous with concurrent micropores (pores sized under 2 nm)+mesopores (pores sized between 2-50 nm) porosity, as described above. Their particles are solid. So, there is a huge difference here in particle physical architecture.

So, ours is superior to theirs, e.g., Borghi et al., mentioned above, and is very different from theirs/prior art.

Please note that, e.g., according to Wikipedia, generally, particles finer than 0.1 μm (10⁻⁷ m) in water remains continuously in motion, due to electrostatic charge (often negative), which causes them to repel each other. Once their electrostatic charge is neutralized by the use of a coagulant chemical, the finer particles start to collide and agglomerate (collect together), under the influence of Van der Waals's forces. For example, long-chain polymer flocculants, such as modified polyacrylamides, are ionic (electric charge related).

Instead of using electrostatic neutralization, NIO (ours) uses concurrent absorption+adsorption for accelerated fine particle agglomeration+elimination. Thus, ours is different from others before/prior art. The performance gain over bulk iron oxide of our NIO for phosphate and for perfluorophosphonic and perfluorosulphonic acids, when coupled with UV light, coupled with its filtering behavior, is unexpected. This is a desirable addition to filtering technology.

Regarding our current invention, it is a commonly held belief that iron oxide (or rust) is a low economic value compound. Yet, if iron oxide particle architecture resembles NIO, it behaves like a Clarifying Agent or Flocculant, dramatically increasing its economic value. NIO creates a brand new classification of Clarifying Agents/Flocculants.

Traditional Clarifying Agents/Flocculants operate by (single process) ionic aggregation. But NIO (ours) uses (dual process of) adsorption+absorption, via:
i. Adsorbent (particle exterior)
ii. Absorbent (nano-porous particle interior):
   1. concurrent microporous, and
   2. mesoporous architecture

NIO is superior to conventional Clarifying Agents in remediation speed+capacity.

In our prior patent mentioned above, please note that we had: Fluid, liquid+gas, applications only. That patent joined a filtration device+a filtration media.

For our current patent, we have: Fluid application and Gas applications, only.

Other methods of separating NIO from water were investigated.

Separate sorbent performance batch quality tests were performed.

+/−500 in-house phosphate remediation performance tests, using reagents in cuvettes, led to the discovery that gravity is an optimal separation method.

+/−20 in-house phosphate remediation performance tests done, against 2 defined Clarifying Agents:
a. ALUM (aluminum sulphate); and
b. Ferrous (iron II) Sulphate

It was demonstrated that:
a. NIO dramatically not only outperformed both Clarifying Agents tested,
b. NIO did so, using source-point concentrations of toxins (phosphates: algae bloom concentrations are almost always <=5 mg/L; our cuvette tests >20 mg/L),
c. Even when NIO dosage reduced to 5% of Clarifying Agents dosages, NIO still dramatically outperformed other clarifying agents.

NIO is also effective against Toxic Heavy Metals.

NIO is also effective against non-polymeric perfluorophosphonic and perfluorosulphonic acids (when UV light is used with NIO).

For current patent, we further have the following (embodiments):

NIO is superior to Clarifying Agents/Flocculants in the prior art.

Application Instructions, as one example (but other variations or ranges are also acceptable/taught here):
1. Recommended for Settling Tank use, ONLY. (Not recommended for use in aquariums, cartridge filters or membrane filters.)
2. NIO degrades, when exposed to air. Do not open NIO container until ready to apply NIO.
3. NIO is shipped with desiccant pellets (e.g., a hygroscopic substance used as a drying agent) used as a preservative and accelerant. Sieve out desiccant pellets before applying NIO.
4. Recommended baseline dosage is 1part NIO to about 20 parts (or in the range of 1 to 100 values) polluted water. Adjust dosage as needed.
5. After NIO is added to polluted water, stir mixture for 5 minutes.
6. After 5 minutes of stirring, allow mixture to settle for 30-90 minutes. Higher concentrations of toxins in water require longer settling detention times.
7. After 30-90 minutes of settling, slowly draw off water from top of tank, so not to disturb NIO settled at bottom of tank.

NIO will slowly begin to dissolve and desorb remediated pollutants in 2 hours, reaching up to 100% desorption in as little as 24 hours.

It is projected that NIO will perform best as polishing agent (final stages of water treatment).

It is projected that NIO will perform best as a source-point sorbent (where pollution concentrations are the highest).

Mixing dosages can be by volume or by weight or by any other measurable units, in our teaching here, for the ratios/dosages.

In one embodiment, we have the following, as an example, but the values can be in a range around that number shown below:

A method for filtering fluid, said method comprising the steps of: providing nano-porous Fe2O3; providing polluted water; mixing said nano-porous Fe2O3 with said polluted water, using a ratio dosage of 1 part of said nano-porous Fe2O3 to 20 parts of said polluted water; stirring said mixture of said nano-porous Fe2O3 and said polluted water, for a stirring period of time; allowing said mixture of said nano-porous Fe2O3 and said polluted water to settle for a settling period of time; and separating water from said settled mixture, with the following options/embodiments:

using dual process of adsorption via particle exterior and absorption via nano-porous particle interior.

removing material from top of said settled mixture.

removing material from bottom of said settled mixture.

removing water from said settled mixture.

wherein said stirring period of time is 5 minutes.

wherein said stirring period of time is 10 minutes.

wherein said stirring period of time is 3 minutes.

wherein said settling period of time is 45 minutes.

wherein said settling period of time is 60 minutes.

wherein said settling period of time is 90 minutes.

using desiccant pellets.

adjusting said ratio dosage.

using process of adsorption via particle exterior.

using absorption via nano-porous particle interior.

combining or adding other clarifying agents.

removing water from said settled mixture, without causing agitation.

using UV light to remove non-polymeric perfluorophosphonic and perfluorosulphonic acids, when coupled with UV light materials, from water.

removing toxic materials from water.

removing toxic heavy metals from water, including antimony, arsenic, cadmium, chromium, cobalt, copper, lead, nickel, selenium, silver, thallium and zinc.

removing phosphorous and phosphate from water.

Any variations of the above teaching are also intended to be covered by this patent application, in addition to the teachings of prior application mentioned above, incorporated here by reference, especially for their FIGURES, appendices, and systems/methods/apparatuses.

1. A method for filtering fluid, said method comprising the steps of:
providing concurrent micro and meso nano-porous Fe₂O₃;
providing polluted water;
mixing said nano-porous Fe₂O₃ with said polluted water, using a ratio dosage of 1 part of said nano-porous Fe₂O₃ to 20 parts of said polluted water;
stirring said mixture of said nano-porous Fe₂O₃ and said polluted water, for a stirring period of time;
allowing said mixture of said nano-porous Fe₂O₃ and said polluted water to settle for a settling period of time; and
separating water from said settled mixture.

2. The method for filtering fluid as recited in claim 1, said method comprises:
using dual process of adsorption via particle exterior and absorption via nano-porous particle interior.

3. The method for filtering fluid as recited in claim 1, said method comprises:
removing material from top of said settled mixture.

4. The method for filtering fluid as recited in claim 1, said method comprises:
removing material from bottom of said settled mixture.

5. The method for filtering fluid as recited in claim 1, said method comprises:
removing water from said settled mixture.

6. The method for filtering fluid as recited in claim 1, wherein said stirring period of time is 5 minutes.

7. The method for filtering fluid as recited in claim 1, wherein said stirring period of time is 10 minutes.

8. The method for filtering fluid as recited in claim 1, wherein said stirring period of time is 3 minutes.

9. The method for filtering fluid as recited in claim 1, wherein said settling period of time is 45 minutes.

10. The method for filtering fluid as recited in claim 1, wherein said settling period of time is 90 minutes.

11. The method for filtering fluid as recited in claim 1, wherein said settling period of time is 30 minutes.

12. The method for filtering fluid as recited in claim 1, said method comprises:
using desiccant pellets.

13. The method for filtering fluid as recited in claim 1, said method comprises:
adjusting said ratio dosage.

14. The method for filtering fluid as recited in claim 1, said method comprises:
using process of adsorption via particle exterior.

15. The method for filtering fluid as recited in claim 1, said method comprises:
using absorption via nano-porous particle interior.

16. The method for filtering fluid as recited in claim 1, said method comprises:
combining or adding other clarifying agents.

17. The method for filtering fluid as recited in claim 1, said method comprises:
removing water from said settled mixture, without causing agitation.

18. The method for filtering fluid as recited in claim 1, said method comprises:
using UV light.

19. The method for filtering fluid as recited in claim 1, said method comprises:
removing phosphate toxic materials from water.

20. The method for filtering fluid as recited in claim 1, said method comprises:
removing heavy metals from water.
